(19) United States
(12) Patent Application Publication
(10) Pub. No.: US 2012/0280935 A1
(43) Pub. Date: Nov. 8, 2012

(54) ARTIFICIAL TOUCH DEVICE FOR ELECTRONIC TOUCH SCREENS

(76) Inventor: Roger Romero, Naples, FL (US)

(21) Appl. No.: 13/102,275

(22) Filed: May 6, 2011

(51) Int. Cl. G06F 3/045

(52) U.S. Cl. 345/174

(57) ABSTRACT

An artificial touch device (1) that creates an electronic circuit between a user's finger and a virtual button (13) on the electronic touch screen (8), such as an electronic touch screen of a smart phone (20) or tablet (21). The artificial touch device comprises a contact portion (2), a transmitting portion (3) and an attachment portion (5). The artificial touch device may be incorporated into video game controllers, such as joysticks, handgun controllers (14), rifle controllers (27), steering wheel controllers, toggle controllers, directional buttons, fishing pole controllers, gas and brake pedal controllers and so forth, on to which a smart phone or tablet may be mounted and/or connected so that a user can control actions within a video game being played on a smart phone or on a tablet.

### BACKGROUND OF THE INVENTION

This invention relates to devices for remotely controlling touch screens, and more particularly to an artificial touch device that allows a user to control virtual buttons displayed on a touch screen without having to physically touch the touch screen.

Many electronic devices, such as smart phones, tablets, televisions, computer screens and so forth use touch screen technology to allow users to control the devices and what is being displayed on the devices. A touch screen is an electronic visual display that can detect the presence and location of a touch within the display area. Many touch screens monitor changes in electrical current on the touch screen. Touching the touch screen with a finger changes the amount of electrical charge at a specific point of contact, thereby sending a signal or command to the electronic device to perform a certain action depending on where the touch screen is being touched. Specific actions are represented by virtual buttons displayed on the touch screen. With the recent introduction of tablets and smart phones having gyroscopes, such devices have become popular as platforms for playing video games. This is especially true for first person shooter games wherein the direction of view of a player changes automatically. The gyroscope detects the position of the smart phone or tablet in space and adjusts the view on the screen accordingly. For example, if a device is tilted so the screen is facing upward then the view on the screen will be of a floor. The actions in such video games, such as firing a gun, directional movement of a character or vehicle and so forth are controlled by physically touching predetermined points or virtual buttons on a touch screen with an individual's finger tips. Conventional video games and video game platforms have allowed players to use accessories such as controllers to enhance game play. However, there are currently no video game controllers that allow a player to control virtual buttons on a touch screen without having to physically touch the touch screen with his or her finger tips.

Therefore, a need exists for an artificial touch device that allows a user to control actions within a video game operating on an electronic device having a touch screen without having to physically touch the touch screen with the user's fingers. In addition, a need exists for an artificial touch device that may be incorporated into conventional video game controllers, such as joysticks, handgun controllers, rifle controllers, steering wheel controllers and so forth, so that video game controllers can be used to control the actions within a videogame operating on an electronic device having a touch screen, such as a smart phone, tablet and so forth.

The relevant prior art includes the following references:

| Pat. No. | | |
|---|---|---|
| (U.S. Patent References) | Inventor | Issue/Publication Date |
| 2010/0289740 | Kim et al. | Nov. 18, 2010 |
| 7,834,847 | Boillot et al. | Nov. 16, 2010 |
| 2010/0170726 | Yeh et al. | Jul. 08, 2010 |
| 2010/0110013 | Li et al. | May 06, 2010 |
| 2010/0095206 | Kim | Apr. 15, 2010 |
| 2010/0079403 | Lynch et al. | Apr. 01, 2010 |
| 7,656,393 | King et al. | Feb. 02, 2010 |
| 7,653,883 | Hotelling et al. | Jan. 26, 2010 |
| 7,646,372 | Marks et al. | Jan. 12, 2010 |
| 2009/0303176 | Chen et al. | Dec. 10, 2009 |
| 7,620,316 | Boillot | Nov. 17, 2009 |
| 2009/0153288 | Hope et al. | Jun. 18, 2009 |
| 7,502,222 | Cheng et al. | Mar. 10, 2009 |
| 2008/0238879 | Jaeger et al. | Oct. 02, 2008 |
| 2008/0059915 | Boillot | Mar. 06, 2008 |
| 7,340,077 | Gokturk et al. | Mar. 04, 2008 |
| 7,242,298 | Cehelnik | Jul. 10, 2007 |
| 7,197,139 | Templin et al. | Mar. 27, 2007 |
| 2006/0221565 | Doherty et al. | Oct. 05, 2006 |
| 7,078,911 | Cehelnik | Jul. 18, 2006 |
| 2006/0109138 | Chiang | May 25, 2006 |
| 6,633,281 | Lin et al. | Oct. 14, 2003 |
| 6,456,275 | Hinckley et al. | Sep. 24, 2002 |
| 6,313,825 | Gilbert | Nov. 06, 2001 |
| 6,130,663 | Null | Oct. 10, 2000 |
| 5,973,677 | Gibbons | Oct. 26, 1999 |
| 5,235,363 | Vogeley et al. | Aug. 10, 1993 |

### (Non-Patent References)

“RoboTouch: Using NES Controller to Play Games on iPad” www.hardwaresphere.com
“AppTpyz GunAccessory for iPhone: Video Game System Rite of Passage” www.technabob.com.

### SUMMARY OF THE INVENTION

The primary object of the present invention is to provide an artificial touch device that allows a user to activate a predetermined location or virtual button on a touch screen without having to physically touch the touch screen.

Another object of the present invention is to provide an artificial touch device that can be incorporated into conventional video game controllers, such as joysticks, hand gun controllers, rifle controllers, steering wheel controllers and so forth to allow the video game controller to be used with electronic devices having touch screens.

The present invention fulfills the above and other objects by providing an artificial touch device that creates an electronic circuit between a user's finger and a predetermined location, such as a virtual button, on a touch screen. The artificial touch device comprises a contact portion, a transmitting portion and an attachment portion. To use the artificial touch device, a user attaches the attachment portion to a touch screen at a location the user wants to remotely touch. The user then touches the contact portion, which is made of a conductive material, either directly or with another conductive material, such as a trigger on a handgun controller. The contact portion then transmits the electrical signal from the user to the attachment portion via the transmitting portion, thereby creating an electrical circuit between the user and the touch screen. The transmitting portion is preferably a conductive wire that connects the contact portion to the attachment portion. However, the transmitting portion may also be a wireless transmission that causes a battery powered contact portion to create an electrical signal, thereby activating the location the user wants to remotely touch. The artificial touch device may be incorporated into controllers, such as joysticks, hand gun controllers, rifle controller, steering wheel controllers, toggle controllers, directional buttons, fishing pole controllers, gas and brake pedal controllers and so forth, on to which a smart phone or tablet may be mounted and/or so that a user can control actions within a video game being played on a smart phone or on a tablet.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side plan view of a preferred embodiment of an artificial touch device of the present invention;

FIG. 2 is a side plan view of an artificial touch device of the present invention attached to a touch screen of an electronic device;

FIG. 3 is a block diagram showing an electrical circuit created between a user and a touch screen using an artificial touch device of the present invention;

FIG. 4 is a perspective rear view of an artificial touch device of the present invention incorporated into a handgun controller;

FIG. 5 is a side partial cutaway plan view of an artificial touch device of the present invention incorporated into a handgun controller;

FIG. 6 is a rear view of an artificial touch device of the present invention incorporated into a handgun controller;

FIG. 7 is a side partial cutaway view of an artificial touch device of the present invention incorporated into a rifle controller; and

FIG. 8 is a perspective side view of an artificial touch device of the present invention incorporated into a rifle controller.

### DESCRIPTION OF THE PREFERRED EMBODIMENTS

For purposes of describing the preferred embodiment, the terminology used in reference to the numbered accessories in the drawings is as follows:

| | |
|---|---|
| 1. | artificial touch device |
| 2. | contact portion |
| 3. | transmitting portion |
| 4. | conductive wire |
| 5. | attachment portion |
| 6. | attachment means |
| 7. | suction cup |
| 8. | touch screen |
| 9. | conductive means |
| 10. | static free foam |
| 11. | electronic device |
| 12. | user |
| 13. | virtual button |
| 14. | handgun controller |
| 15. | mounting means |
| 16. | magnet |
| 17. | clip |
| 18. | bracket |
| 19. | upper surface |
| 20. | smart phone |
| 21. | tablet |
| 22. | actuating means |
| 23. | trigger |
| 24. | handle |
| 25. | aperture |
| 26. | retractable spool |
| 27. | rifle controller |
| 28. | button |
| 29. | magnetic U-shaped bracket |
| 30. | static free rubber |

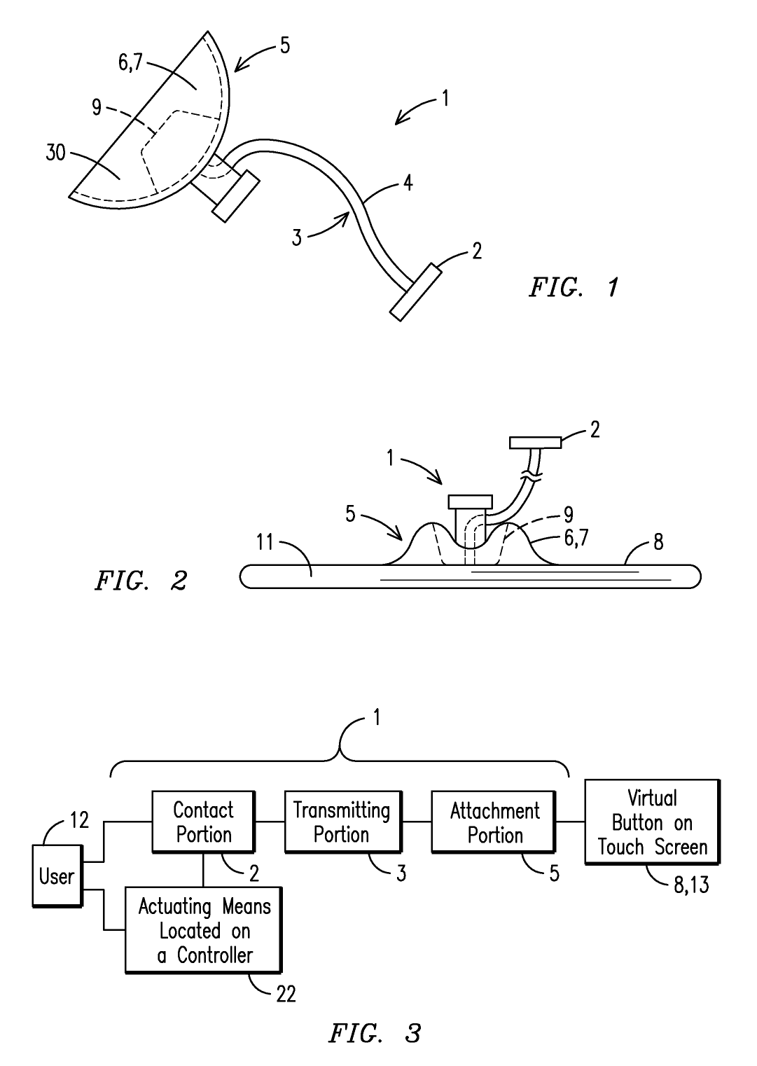

With reference to FIG. 1, a side plan view of an artificial touch device 1 of the present invention is illustrated. The artificial touch device 1 comprises a contact portion 2, a transmitting portion 3, such as a conductive wire 4, and an attachment portion 5. The attachment portion 4 has an attachment means 6, such as a suction cup 7, an adhesive and so forth, that attaches the attachment portion 5 to a touch screen 8 as illustrated in subsequent figures. The attachment portion 4 may be made of a conductive means 9, such as a static free rubber 30. For example, the suction cup 7 illustrated in FIG. 1 is constructed from a static free rubber 30. Alternatively, a conductive means 9, such as a static free foam 10, static free rubber and so forth, may be located in the attachment portion 5, as illustrated in FIG. 2.

With reference to FIG. 2, a side plan view of an artificial touch device 1 of the present invention attached to a touch screen 8 of an electronic device 11 is illustrated. When the attachment portion 5 is attached to a touch screen 8, the attachment portion 5 presses conductive means 9 against the touch screen 8, thereby ensuring that the conductive means 9 maintains constant contact with the touch screen 8. As illustrated here, the attachment means 6 is a suction cup 7 that is pressed against the touch screen 8 to attach the attachment portion 5 to the touch screen 8. By pushing the suction cup 7 against the touch screen 8 the conductive means 9 is also pressed against the touch screen 8.

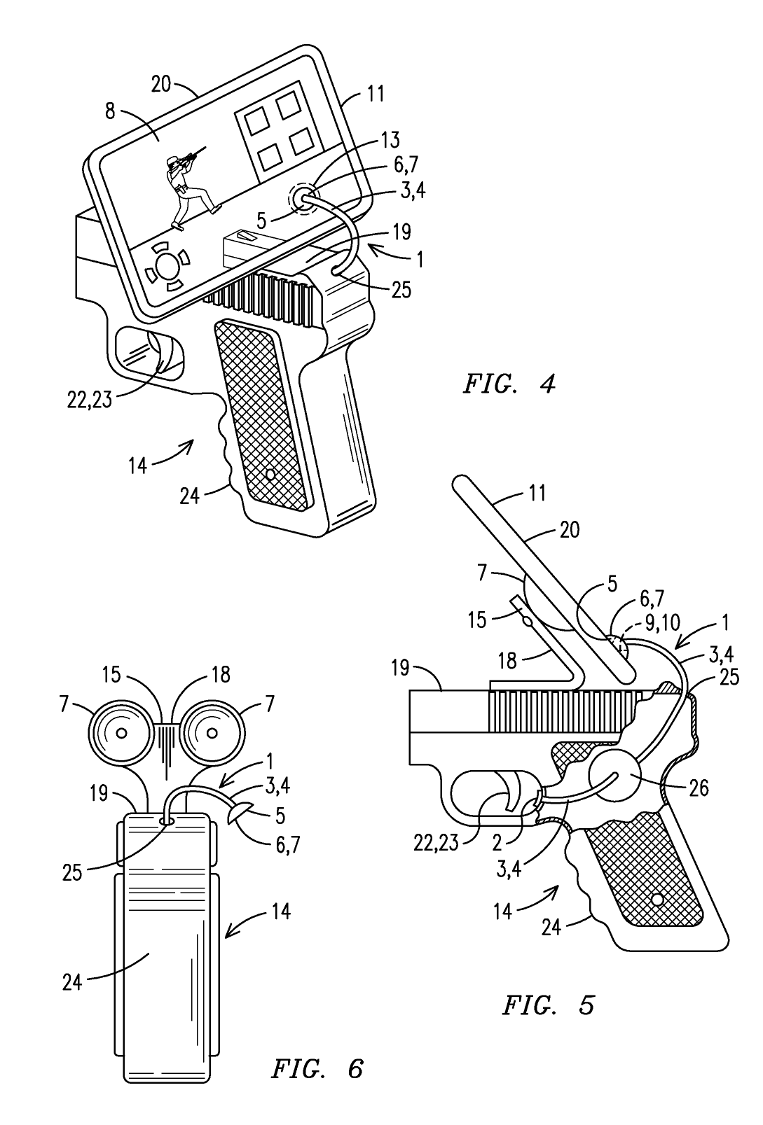

With reference to FIG. 3, a block diagram showing an electrical circuit created between a user 12 and a touch screen 8 using an artificial touch device 1 of the present invention is illustrated. To use the artificial touch device 1, a user secures the attachment portion 5 to a touch screen 8 over a virtual button 13 displayed on the touch screen 8, as shown in FIG. 4. When the user 12 touches the contact portion 2, which is made of a conductive material, an electrical signal is passed from the user 12 to the contact portion 2, then to the attachment portion 5 via the transmitting portion 3. Alternatively, the user 12 may touch an actuating means 22 that is made of a conductive material or has a conductive material located thereon that passes an electrical signal from the user 12 to the contact portion 2. After the electrical signal is passed to the contact portion 2, the electrical signal is passed to the virtual button 13 on the touch screen 8, thereby creating an electrical circuit between the user 12 and the touch screen 8 that activates the virtual button 13. The transmitting portion 3 is preferably a conductive wire 4 that connects the contact portion 2 to the attachment portion 5. However, the transmitting portion 3 may also be a wireless transmission sent from the contact portion 2 to a battery powered attachment portion 5 to create an electrical circuit, thereby activating the virtual button 13 the user 12 wants to remotely touch.

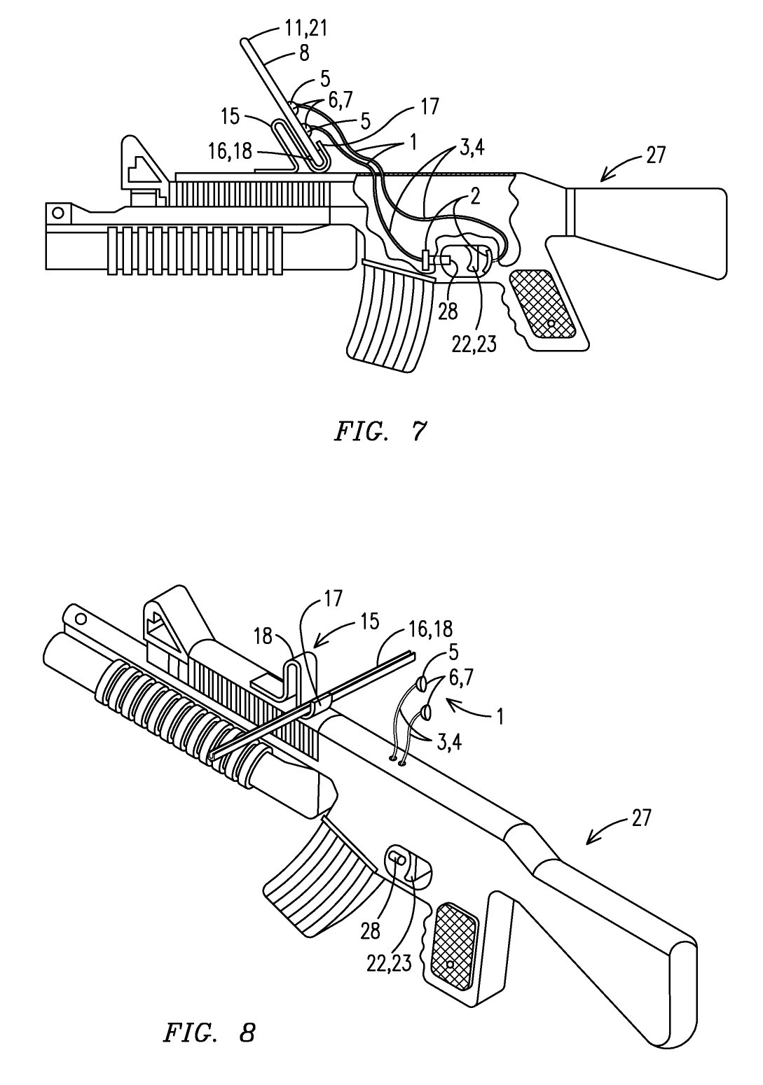

With reference to FIGS. 4, 5 and 6, a perspective rear view, a side partial cutaway plan view and a rear view, respectively, of an artificial touch device 1 of the present invention incorporated into a hand-gun controller 14 is illustrated. The artificial touch device 1 comprises a contact portion 2, a transmitting portion 3 and an attachment portion 5. The attachment portion 5 has an attachment means 6, such as a suction cup 7, an adhesive and so forth, that attaches the attachment portion 5 to a touch screen 8 over a virtual button 13 located on the touch screen 8. The attachment portion 4 may be made of a conductive means 9, such as a static free rubber 30. For example, the suction cup 7 illustrated in FIG. 1 is constructed from a static free rubber 30. Alternatively, a conductive means 9, such as a static free foam 10, static free rubber and so forth, may be located in the attachment portion 5, as illustrated in FIG. 2. A mounting means 15, such as suction cups 7, magnets 16, clips 17, brackets 18 and so forth, is located on an upper surface 19 of the hand gun controller 14. The mounting means 15 may also be a retractable clip that is pulled upward out of the gun controller 14. The retractable clip has a hook shaped top end that exerts downward pressure via a spring on an electronic device, thereby locking the electronic device in place. An electronic device 11, such as a smart phone 20 or tablet 21, is mounted on the hand gun controller 14 via the mounting means 15. An actuating means 22, such as a trigger 23, is located on the handgun controller 14 and is made of a conductive material so that when a user squeezes the trigger 23, the trigger 23 makes contact with the contact portion 2 located directly behind the trigger 23, thereby sending an electrical signal from the user 12 to the contact portion 2, then to the attachment portion 5 via the transmitting portion 3. Then the electrical signal is passed to the virtual button 13 on the touch screen 8, thereby creating an electrical circuit between the user 12 and the touch screen 8 that activates the virtual button 13. The transmitting portion 3 is preferably a conductive wire 4 located within a handle 24 of the handgun controller 14. The conductive wire 4 passes through an aperture 25 located on the upper surface 19 of the handgun controller 14. The conductive wire 4 may be partially stored on a retractable spool 26 as shown in FIG. 4, thereby ensuring that there is no excess conductive wire 4 between the retractable spool 26 and the touch screen 8.

With reference to FIGS. 7 and 8, a side partial cutaway view and a perspective side view, respectively, of an artificial touch device 1 of the present invention incorporated into a rifle controller 27 is illustrated. The artificial touch device 1 comprises a contact portion 2, a transmitting portion 3 and an attachment portion 5. The attachment portion 5 has an attachment means 6, such as a suction cup 7, an adhesive, etc., that attaches the attachment portion 5 to a touch screen 8 over a virtual button 13 located on the touch screen 8. The attachment portion 4 may be made of a conductive means 9, such as a static free rubber 30. For example, the suction cup 7 illustrated in FIG. 1 is constructed from a static free rubber 30. Alternatively, a conductive means 9, such as a static free foam 10, static free rubber and so forth, may be located in the attachment portion 5, as illustrated in FIG. 2. A mounting means 15, such as suction cups 7, magnets 16, clips 17, brackets 18 and so forth, is located on an upper surface 19 of the rifle controller 27. On of the mounting means 15 shown in FIG. 8 comprises a magnetic U-shaped bracket 29 that is preferably contoured to an edge of an electronic device holds a lower edge of an electronic device 11. An electronic device 11, such as a smart phone 20 or tablet 21, is mounted on the rifle controller 27 via the mounting means 15. One or more actuating means 22, such as a trigger 23 or button 28, is located on the rifle controller 27. The trigger 23 is made of a conductive material so that when a user squeezes the trigger 23, the trigger 23 makes contact with the contact portion 2 located directly behind the trigger 23, thereby sending an electrical signal from the user 12 to the contact portion 2, then to the attachment portion 5 via the transmitting portion 3. Then the electrical signal is passed to the virtual button 13 on the touch screen 8, thereby creating an electrical circuit between the user 12 and the touch screen 8 that activates the virtual button 13. The button 28 is made of or has a conductive material located thereon so that when a user pushes the button 28, the button 28 makes contact with the contact portion 2 located directly behind the button 28, thereby sending an electrical signal from the user 12 to the contact portion 2, then to the attachment portion 5 via the transmitting portion 3. Then the electrical signal is passed to the virtual button 13 on the touch screen 8, thereby creating an electrical circuit between the user 12 and the touch screen 8 that activates the virtual button 13. The transmitting portions 3 are preferably conductive wires 4 located within the rifle controller 27. The conductive wires 4 pass through apertures 25 located on the upper surface 19 of the rifle controller 27.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. An artificial touch device for remotely activating a virtual button located on an electronic touch screen comprising:
a contact portion and an attachment portion connected together by a transmitting means that transmits electrical charges from the contact portion to the attachment portion;
an attachment means for attaching the attachment portion to the electronic touch screen; and
said attachment portion having a conductive means that transmits electrical charges from the transmitting means to the electronic touch screen.

2. The artificial touch device of claim 1 wherein:
said transmitting means is a conductive wire.

3. The artificial touch device of claim 1 wherein:
said attachment means is a suction cup.

4. The artificial touch device of claim 1 wherein:
said attachment means is an adhesive.

5. The artificial touch device of claim 1 wherein:
said attachment portion is constructed out of a conductive means.

6. The artificial touch device of claim 1 wherein:
said conductive means is located on the attachment portion.

7. The artificial touch device of claim 1 wherein:
said conductive means is a static free foam.

8. The artificial touch device of claim 1 wherein:
said conductive means is a static free rubber.

9. The artificial touch device of claim 1 wherein:
said artificial touch device is incorporated into a video game controller.

10. The artificial touch device of claim 9 wherein:
said video game controller is a handgun controller.

11. The artificial touch device of claim 9 wherein:
said video game controller is a rifle controller.

12. The artificial touch device of claim 9 wherein:
said video game controller further comprises and actuating means having a conductive material located thereon that passes an electrical charge from a user through the conductive material to the contact portion of the artificial touch device when the actuating means is pressed against the contact portion by the user.

13. The artificial touch device of claim 12 wherein:
said actuating means is a trigger.

14. The artificial touch device of claim 12 wherein:
said actuating means is a button.

15. The artificial touch device of claim 9 wherein:
said video game controller further comprises a mounting means for mounting an electronic touch screen device.

16. The artificial touch device of claim 11 wherein:
said mounting means is at least one suction cup.

17. The artificial touch device of claim 11 wherein:
said mounting means is at least one clip.

18. The artificial touch device of claim 11 wherein:
said mounting means is at least one bracket.

19. The artificial touch device of claim 11 wherein:
said mounting means is at least one magnet.

20. The artificial touch device of claim 11 wherein:
said mounting means is at least one magnetic substantially U-shaped bracket.
